(19) United States
(12) Patent Application Publication
(10) Pub. No.: US 2012/0036476 A1
(43) Pub. Date: Feb. 9, 2012

(54) MULTIDIRECTIONAL EXPANSION CURSOR AND METHOD FOR FORMING A MULTIDIRECTIONAL EXPANSION CURSOR

(76) Inventor: Eui Jin Oh, Daejeon (KR)

(21) Appl. No.: 13/265,156

(22) PCT Filed: Apr. 23, 2010
(86) PCT No.: PCT/KR10/02562

§ 371 Date: Oct. 19, 2011

(30) Foreign Application Priority Data
Apr. 23, 2009 (KR) 10-2009-0035360
May 18, 2009 (KR) 10-2009-0043250
Oct. 8, 2009 (KR) 10-2009-0095409

(51) Int. Cl. G06F 3/048

(52) U.S. Cl. 715/811; 715/835; 715/834

(57) ABSTRACT

A multidirectional expansion cursor and method of implementing the same are provided. The multidirectional expansion cursor displayed on a display screen and moved under input control of a user includes selection keys, wherein the selection keys are displayed on the display screen such that the selection keys correspond to one or more object selectable on the display screen, and, when an intended object among the one or more objects is selected by input control of a user, the intended object is executed. The method includes generating an expansion cursor displayed on a display screen to be moved under input control of a user, and partitioned by selection keys, making one or more objects selectable on the display screen correspond to the selection keys and displaying them on the display screen, selecting the selection key corresponding to an intended object to execute the intended object among the one or more objects.

### TECHNICAL FIELD

The present invention relates to a multidirectional expansion cursor partitioned by radial-typed selection keys and a method of implementing the same. And more particularly, the present invention relates to a multidirectional expansion cursor having an excellent user immediacy and a user friendly environment in which a user can quickly, conveniently, and accurately select a desired specific object by only closely placing a cursor on the specific object without effort of exactly placing the cursor on the specific object displayed on a display screen and then indicate desired contents or execute the object, and a method of implementing the same.

### BACKGROUND ARTS

With a development of an OS environment from DOS to Window, a user interface on a display screen has emerged as a significantly important element. That is, an environment is generally used in which a use can easily grasp details of corresponding contents through arrangements of objects such as various kinds and types of contents in an unspecific location of the display screen, and also easily access the corresponding contents by using a mouse.

Further, a user interface, which can be visually displayed and conveniently selected, is more important in a portable terminal having the relatively small number of keys of a keypad in comparison with a PC or a notebook.

However, in order to select specific contents displayed on a display screen in a current electronic device, a user should perform an operation while exactly placing a mouse cursor, an optical sensor typed pointer, or an input tool such as a joystick or a finger on the contents or an object. However, for example, when the user desires to move a cursor, it is difficult to precisely move the cursor. Further, when the user moves the cursor by using his/her finger, it is difficult to accurately select only an intended content in a case where a plurality of contents are closely positioned to each other since a size of an indication such as an icon indicating a content is smaller than a size of a person's finger. Particularly, smooth selection and control are not easy in a mobile device in comparison with a selection and a control performed by using a mouse in a game, a web, and an office work. That is, it is difficult to precisely control a mouse pointer and it is very difficult to accurately select and control a small button and a line displayed on a screen by using a finger and control. Accordingly, a user should repeatedly perform the above different procedures many times due to a wrong selection, so that there are problems in that fatigue of the user is increased and it is difficult to quickly and accurately make a control in comparison with a control performed by using a mouse of a desktop PC in a game, a web, and an office work.

Further, a conventional cursor functions as a tool simply for selecting contents. That is, the cursor is used as a tool by which a user move the cursor to place it on contents and the user can select the specific contents so that intention of the user may be identified. Accordingly, the cursor is used only for a selection purpose except a case where an additional function is selected by using left and right buttons of a mouse. Further, even in a case where the additional function is selected by using left and right buttons of the mouse, the user should additionally perform one selection procedure after selecting one button from left and right buttons. As a result, a quick and accurate input is highly limited.

### DISCLOSURE OF INVENTION

### Technical Problems

The present invention has been made to provide a multidirectional expansion cursor and a method of implementing the multidirectional expansion cursor which has excellent user immediacy and can quickly and accurately select an intended object among one or more objects only by closely placing the cursor on a specific object even in a limited size of a screen.

The present invention has also been made to provide a multidirectional expansion cursor and a method of implementing the multidirectional expansion cursor which can performs various functional instructions in a display screen through an input display unit connected to the cursor.

The present invention has also been made to provide a multidirectional expansion cursor and a method of implementing the multidirectional expansion cursor which can arrange a plurality of randomly arranged objects to identify them and, after an input of a search word, arrange objects corresponding to the search word according to an intended standard to use the objects.

The present invention has also been made to provide a multidirectional expansion cursor and a method of implementing the multidirectional expansion cursor which can 3-dimensionally arrange a lot of objects to easily and quickly identify contents of the objects.

### Technical Solution

In order to achieve the foregoing and/or other aspects of the present invention, there is provided a method of implementing a multidirectional expansion cursor, the method including: generating an expansion cursor displayed on a display screen to be moved according to an input control of a user, and partitioned by a plurality of selection keys; making one or more objects selectable on the display screen correspond to the selection keys and displaying them on the display screen; and selecting the selection key corresponding to an intended object in order to execute the intended object among the one or more objects.

There is provided a multidirectional expansion cursor, which is displayed on a display screen and can be moved according to an input control of a user, the multidirectional expansion cursor including: a plurality of selection keys, wherein the selection keys are displayed on the display screen such that the selection keys correspond to one or more object selectable on the display screen, and, when an object corresponding to an intended object among the one or more objects is selected by an input control of a user, the intended object is executed.

### Advantageous Effects

According to the present invention, an intended object among one or more objects is quickly and accurately selected only by closely placing the cursor on a specific object. As a result, there is an effect in that a quick and accurate selection operation may be performed without accurately placing the cursor on the intended object.

Further, according to the present invention, various functional instructions may be performed in a display screen through a basic cursor or an expansion cursor, so that there is an advantage in that it is possible to easily perform inputs of data including a text and inputs of various instructions through a close selection even in a narrow input space.

Moreover, according to the present invention, there is an effect in that a user arranges a plurality of randomly disposed objects to identify them, and, after an input of a search word, arranges objects corresponding to the search word according to an intended standard to use the objects, so that the user can easily select a desired object.

Furthermore, according to the present invention, there is an advantage in that a user 3-dimensionally arranges a lot of objects, so that the user can easily and quickly identify contents of the objects.

### BRIEF DESCRIPTION OF THE DRAWINGS

The objects, features and advantages of the present invention will be more apparent from the following detailed description in conjunction with the accompanying drawings, in which:

FIG. 1 is a flowchart of a method of implementing an expansion cursor according to the present invention;

FIG. 2 is a perspective view of an example of an electronic device implemented by a method according to the present invention;

FIGS. 3 to 9 illustrate specific embodiments of the method according to the present invention;

FIG. 10 illustrates a usual usage example of an expansion cursor according to the present invention;

FIGS. 11 and 12 illustrate another example of the electronic device implemented by the method according to the present invention;

FIG. 13 illustrates an embodiment in which the method is implemented in a game according to the present invention;

FIGS. 14 and 15 illustrate an implementation example for a second embodiment of the method of implementing an expansion cursor according to the present invention;

FIG. 16 illustrates a modification example for the second embodiment according to the present invention;

FIGS. 17 to 19 illustrate an implementation example for a third embodiment of the method of implementing an expansion cursor according to the present invention;

FIG. 20 illustrates a modification example for the third embodiment according to the present invention;

FIG. 21 illustrates that the present invention is operated in an office application; and

FIG. 22 is a block diagram schematically illustrating a construction of a user terminal, in which a fourth embodiment of the present invention is implemented, according to the present invention.

### EMBODIMENTS OF INVENTION

Hereinafter, the embodiment of the present invention will be described in detail with reference to the accompanying drawings so that those skilled in the art may easily perform the present invention. In the drawings, in order to clearly describe the present invention, parts that are not related to description are omitted and similar elements are denoted by similar reference numerals throughout the specification.

Throughout the specification, when an element is referred to as “being included”, unless there is anything particularly written to the contrary, it means that other elements are not excluded but may be further included. In addition, the terms of ‘. . . module’ and ‘. . . unit’ written in the specification mean units for processing at least one function or operation and may be realized by hardware, software, or a combination of hardware and software.

### First Embodiment

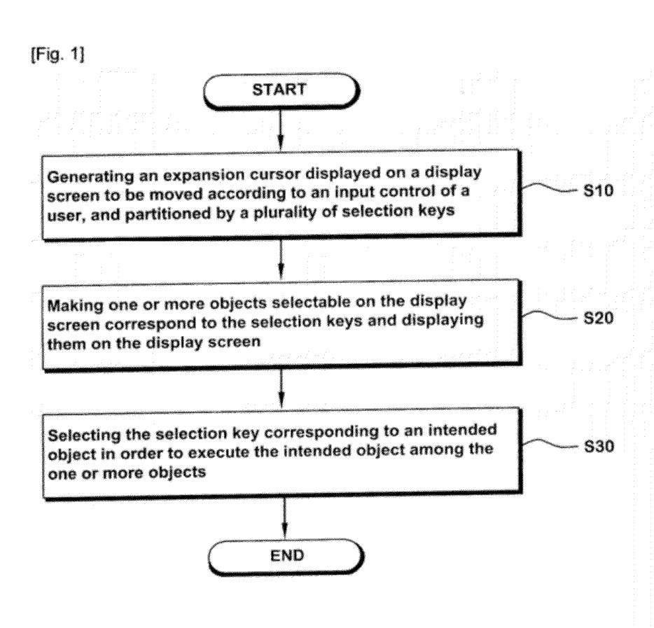

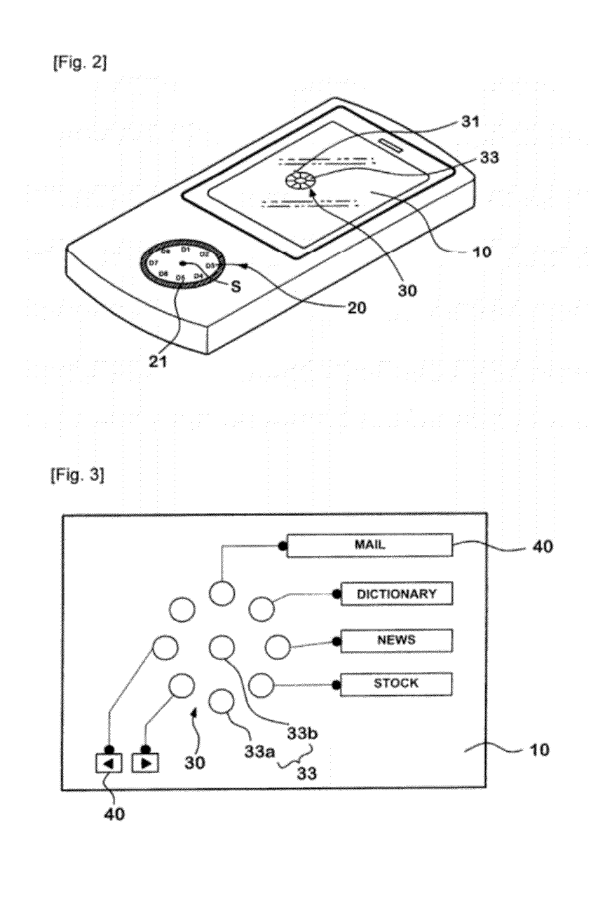

FIG. 1 is a flowchart of a method of implementing an expansion cursor according to the present invention, FIG. 2 is a perspective view of an example of an electronic device implemented by a method according to the present invention, and FIGS. 3 to 9 illustrate specific embodiments of the method according to the present invention.

First, the electronic device implemented by the present invention is enough if it includes a display screen 10, and an input means 20 for allowing a plurality of inputs for a plurality of selections and a movement of a basic cursor 31 operated on the display screen 10. That is, the electronic device may be a portable terminal having a type shown in FIG. 2, and may be various devices such as a computer, a notebook, and a PDA. In general, the basic cursor refers to an object which waits for an input or indicates a location on a display device such as a computer monitor. Further, the basic cursor corresponds to a cursor having directivity, which can move according to a control by an input means such as a mouse, and a shape of the basic cursor may be variously represented by a selection according to an implementation environment of a person skilled in the art.

The multidirectional expansion cursor according to the present invention may be displayed on the display screen 10 to move according to an input control of a user and has a plurality of selection keys 33. The selection keys 33 are displayed on the display screen 10 such that the selection keys correspond to one or more objects 40 selectable on the display screen 10. When the selection key 33 corresponding to an intended object 40 among the one or more objects is selected by an input control of a user, the intended object 40 is executed.

A method according to the present invention is initiated at a step of generating the basic cursor 31 displayed on the display screen 10 to move, and an expansion cursor 30, which is connected to the basic cursor 31 to move together with the basic cursor 31 and includes the plurality of selection keys 33: 33a and 33b. Here, the “expansion cursor” is not a cursor, which is generally used, like the basic cursor, and refers to a type of a cursor, which can be expanded according to a predetermined condition such as a system environment setting of a user and make each of plural objects displayed on the screen correspond to the selection key.

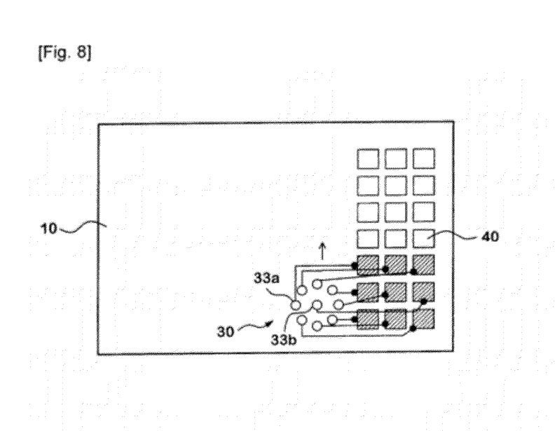

Further, in embodiments of the present invention, there is an example in which the expansion cursor includes the basic cursor. However, the basic cursor may be omitted according to a deactivation option selection of a user, and the basic cursor may be located in the center of the expansion cursors (see FIG. 7). Particularly, if the user can grasp the directivity through a shape of the expansion cursor, the need, in which the basic cursor is included in the expansion cursor to be displayed, further shrinks.

As described above, the basic cursor 31 performs a similar operation and function as the cursor 31 commonly used. However, an end of the basic cursor 31 is integratively connected to the expansion cursor 30 as shown in FIG. 2. Here, it should be noted that the expansion cursor is not subordinate to the basic cursor, and it may be understood that an outside end of the expansion cursor is integratively connected to the basic cursor through an option setting of a user according to a user environment. As described above, the basic cursor 31 may be positioned in the center of the expansion cursors or may not be displayed according to structures or shapes of the expansion cursors or the selection keys as shown in FIG. 7. Particularly, when the basic cursor is separated from an object more than a predetermined distance away, the basic cursor is displayed together with the expansion cursor. Then, when the basic cursor approaches within a predetermined distance from the object, the shape of the expansion cursor is changed and not displayed, or the location or the shape of the basic cursor may be changed when the shape of the expansion cursor is changed. At this time, it is preferable to normally form the expansion cursor such that the expansion cursor 30 has the size same as or slightly larger than that of the basic cursor 31 so that there is no inconvenience in a movement of the basic cursor 31 and a selection through the basic cursor 31. Further, it is natural that the basic cursor 31 is not displayed on an initial screen, and only the expansion cursor 30 may be operated at that time.

In addition, the expansion cursor 30 is formed in a circular shape as shown FIG. 2, and includes a plurality of selection keys 33a and 33b positioned at the center and radially partitioned locations from the center. At this time, the selection key 33b positioned at the center may be omitted, and the number of selection keys 33 may be changeable as necessary. Further, shapes of the expansion cursor and the selection key may be a geometrically possible plane or solid figure as well as a circular shape. It is natural that the plural numbers of radially partitioned sections and selection keys may be formed. However, it is preferable that the number is in a range of 4 to 13 in terms of maintaining accuracy, immediacy, and speed.

Meanwhile, one or more objects may be displayed on the display screen 10 (see FIG. 3). At this time, the object may be a user interface, a link, a hypertext, a simple text, a thumbnail image or an icon image, a thumbnail movie, various multimedia contents, something formed by combining one of them with link information, something formed by combining a compound of a text and a thumbnail image with link information, a compound of a text and a thumbnail movie with link information, a TV image, various dynamic images, players itself of the TV image and the dynamic image, contents such as document data, image data, sound source data, dynamic image data, something formed by combining two or more data among the data, an application program, data using a markup language such as html, xml, and sgml. In a case where the object is data using the markup language, it is apparent to a person skilled in the art that corresponding contents or a contents menu may include URL (Uniform Resource Locator) or link information indicating a local storage route, and refer to contents, a menu, an icon, a folder, a character, an item, or a graphic indication object. Further, it is apparent to a person skilled in that art that a range of the object is not limited thereto. In embodiments of the present invention, it is described that the objects 40 refer to contents menus as shown in figures for convenience of the description. The object can be anything which may be moved to an actual content or display details related to the contents after a user clicks or executes the object by using a general cursor. For example, the object 40 may be represented in a form of a picture, a word, a phrase, or a symbol, and may be represented as a character in a game. That is, when the object 40 is represented in a picture form, if the object is clicked or executed, details corresponding to the picture are displayed, a screen is moved to a corresponding homepage, or the picture may be enlarged to be displayed on the display screen. Further, when the object 40 is represented in a word or phrase form, if the object is clicked (or executed), details represented by the word or phrase are displayed or the screen may be moved to a corresponding homepage. In addition, the object corresponds to a character of a game in the game, so that a selection for the character or a command for a specific movement of the character may be performed when the object is clicked or executed.

Furthermore, the object may be a graphic indication object such as various types and sizes of windows displayed on the display screen.

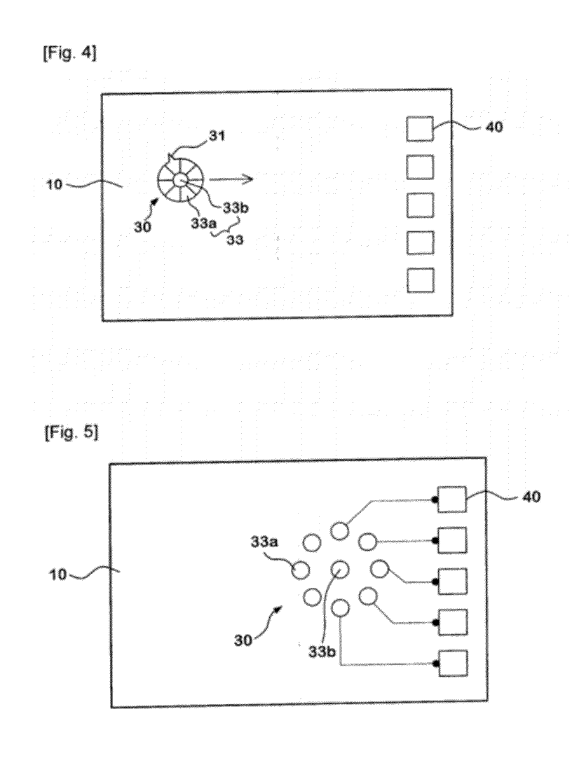

Next, when the expansion cursor 30 shown in FIG. 4 approaches the object 40, a shape of the expansion cursor 30 is changed as shown in FIGS. 5 to 7 and one or more objects positioned within a predetermined distance and the selection key 33a of the display unit 33 are connected to each other. At this time, all the selection keys 33 do not have to be connected to the object 40. When the number of selection keys 33 is 9, it is preferable that each of the selection key is connected to the object 40 most closely positioned to the selection key 33. Further, a dotted line indicated in the center of the display screen 10 in FIGS. 4 to 7 refers to a virtual line for describing a range of a distance for connecting the object 40 and the selection key 33. The virtual line is not limited to a horizontal or vertical line, and means a virtual distance or interval from a plurality of objects. That is, the virtual line means a range by which a close selection is possible.

Further, when the objects 40 adjacent to the expansion cursor 30 is distributed as much as the same number of selection keys 33, each selection key 33 of the expansion cursor 30 may be connected to each object 40.

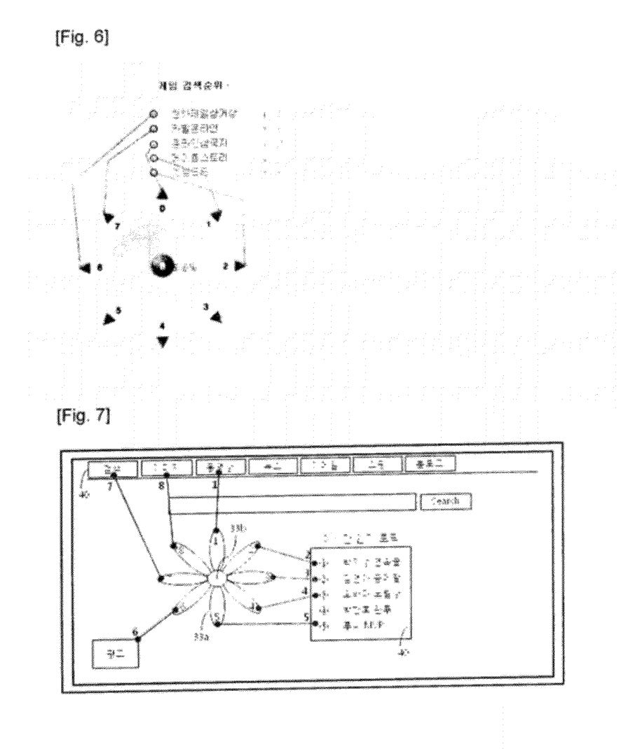

In addition, the selection key 33 of the expansion cursor 30 shown in FIG. 5 has a circular shape, but the shape is not limited thereto. For example, as shown in FIG. 6, the selection key 33 may have a small triangular shape radially disposed in a circular orbit. At this time, the circular orbit may be transparent, but may be implemented to have a proper skin or color for the visual beauty in an actual implementation. Particularly, as shown in FIGS. 6 and 7, numbers are indicated inside the selection keys and a user directly presses a corresponding number in a keypad manner or an input manner such as a keyboard or a button key so that a selected menu may be accessed. Here, numbers are illustrated in embodiments of the present invention, but a person skilled in the art can indicate other words or symbols other than numbers according to an input means as necessary. Of course, nothing may be indicated. Further, as shown in FIG. 7, the selection keys may be implemented to have a plurality of elongated ovals radially disposed and all or some of the selection keys may have a color or may be transparent. As easily expected from the above description, it is apparent that a person skilled in the art can variously modify or change the shape and the structure of the selection key as well as the shape of the expansion cursor according to an environment required for an implementation by the person skilled in the art.

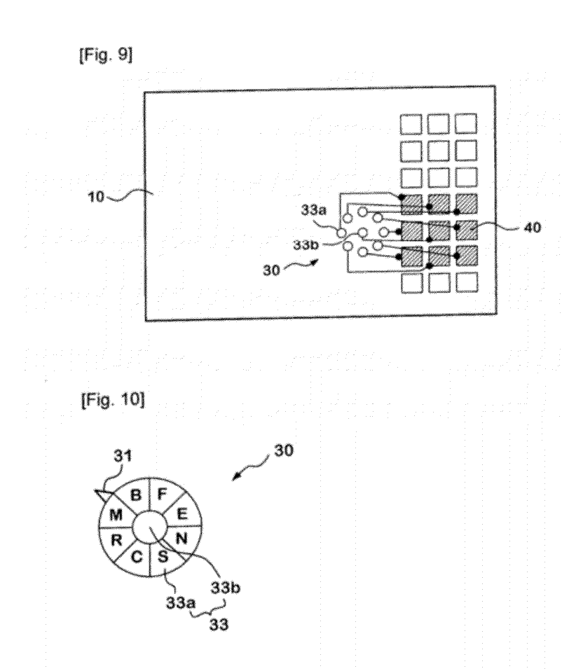

As shown in FIG. 8, when the number of objects 40 is larger than the number of selection keys 33 of the expansion cursor 30, only objects 40 positioned adjacent to the expansion cursor 30 are first connected to the selection keys 33 individually. Further, when the expansion cursor 30 is moved in a specific direction in this state (for example, the expansion cursor is moved in a direction indicated by an arrow in FIG. 8), the objects 40 positioned adjacent to the expansion cursor 30 are individually connected to the selection keys 33 based on a moved state as shown in FIG. 9.

Meanwhile, when the selection keys 33 and the objects 40 are connected to each other in the expansion cursor 30, the basic cursor 31 is omitted from a first state shown in FIG. 2 and each selection key 33 is expanded in the expansion cursor 30 (see FIGS. 3, and 5 to 7), the basic cursor may be positioned at the center of the expanded selection keys or may not be displayed.

As described above, when the object 40 and the selection key 33 displayed on the display screen 10 are connected to each other, a user can access and identify details corresponding to the object by selecting the selection key 33 connected to the specific object 40. For example, as shown in FIG. 3, the user desires to click contents “news” in a state where the object 40 and the selection key 33 are connected to each other, a current screen may be moved to a screen displaying details of the contents by selecting the selection key 33 positioned in a direction of 3 o'clock.

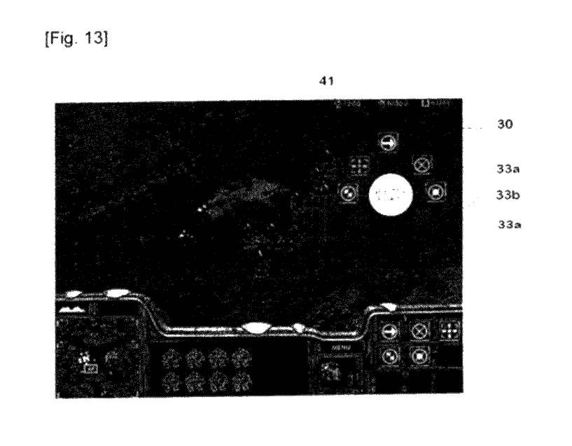

Meanwhile, when a game is executed, if the expansion cursor 30 is moved within a predetermined distance from the character 41, the selection key 33 of the expansion cursor 30 is expanded and the selection key 33 is connected to the character 41 within a predetermined distance. More specifically, as shown in FIG. 13, when Star-craft game is executed, if the expansion cursor is closely moved to the character of zealot, the selection key 33 of the expansion 30 is expanded and connected to the character 41. In this embodiment of the present invention, 8 zealots are connected to the central selection key 33b based on an assumption that 8 zealots are positioned within a predetermined distance. Here, the number of characters connected to the central selection key 33b may be changed by a separate setting. When characters more than the predetermined number of characters are positioned within a predetermined distance, the closest character is first connected to the selection key 33b and next closest character is connected to the selection key. Further, FIG. 13 illustrates that the character is connected to the central selection key 33b, but one or more characters may be connected to radially disposed neighbor selection keys 33a through a setting change.

FIG. 13 illustrates that the central selection key 33b can perform a function of “selection/release”. The function corresponds to automatically releasing a connection relation between the selection key 33b and the character 41 connected to the selection key 33b or connecting them again.

Further, various instructions for the character which may be performed by a direct selection of a shortcut key or a general cursor may be indicated in neighbor selection keys 33a. In FIG. 13, reciprocating movement instruction in left and light directions, an attack instruction, a movement instruction, a stop instruction, and a hold instruction are disposed in the neighbor selection keys 33a. A user selects one instruction from the above instructions and then the corresponding instruction may be performed. In this embodiment, a situation is described where a user selects a selection key corresponding to an attack instruction of 11 o'clock, and then 8 zealots attack together.

At this time, a movement of the expansion cursor 30 and a selection of the selection keys 33 are performed by an input means 20. That is, the input means 20 may include a general input means such as a keyboard and a keypad, and may include an input device (hereinafter, referred to as an “input device 1”), which is a filed invention (patent application no. 2007-0045255) in advance by the same inventor as this application. The input device 1 may be provided integratively with a portable terminal as shown in FIG. 2, or may be connected to the terminal through USB and used as a separate device.

Further, the input device 1 includes an input unit 21, a first detector (not shown), a second detector (not shown), and a controller (not shown). More specifically, the input unit 21 is arranged adjacent to the display screen 10, a first direction input and a second direction input are configured to be performed independently or simultaneously. The first direction input allows a movement to one among a plurality of instruction locations D1, D2, D3 . . . radially spaced apart from each other based on a reference location S, and the second direction input refers to pressing one of the above instruction locations.

Further, the first detector is configured to detect the first direction input, and the second detector is configured to detect the second direction input.

In addition, when the first direction input is performed, the controller extracts first data corresponding to the first direction input of the instruction locations from a memory (not shown) and then inputs the data. When the second direction input is performed, the controller extracts second data corresponding to the second direction input of the instruction locations from a memory (not shown) and then inputs the data.

At this time, the plurality of instruction locations are configured to correspond to the plurality of selection keys 33 and have numbers corresponding to the number of a plurality of selection keys 33. When the first direction input or the second direction input for the input unit is performed, the controller determines that the selection key 33 corresponding to an instruction location where the direction input is performed is selected, and performs a selection instruction of an object 40 corresponding to the selection key 33.

Further, since the first direction input and the second direction input are independently or simultaneously performed for the plurality of instruction locations, if only one of the first direction input and the second direction input is performed in order to select a selection key 33 corresponding to each of the instruction locations, it may be processed as if the selection key 33 has been selected.

Alternatively, a selection for the selection key 33 is performed by only the second direction input, and the first direction input may be used for a movement of the expansion cursor 30.

Further, when the selection key 33 and the object 40 are not connected to each other, the second direction input may be used to input separate data. For example, when the expansion cursor 30 is in a state as shown in FIG. 2, each selection key 33 is allocated an instruction such as “previous screen B”, “next screen F”, “enter E”, “refreshment N”, “screen size adjustment S”, “screen close C”, “favorites R”, or “mode conversion M”. When the second direction input for a corresponding selection key 33 is performed to select a specific instruction, the instruction may be configured to be performed (see FIG. 10). At this time, the specific instruction may be represented by one alphabet among the alphabets indicating instructions listed above as shown in FIG. 10, but may be represented in a picture form to be more easily grasped visually.

Further, alphabets or Korean alphabets are arranged in the selection keys 33 and a character input is normally performed by the first direction input and the second direction input. The first direction input and the second direction input may be used for a movement of the expansion cursor 30 and a selection of the selection keys 33 by selecting the central selection key 33 or a separate key.

The input device 1 may include a central input unit (not shown) for selecting the central selection key 33 on the input unit.

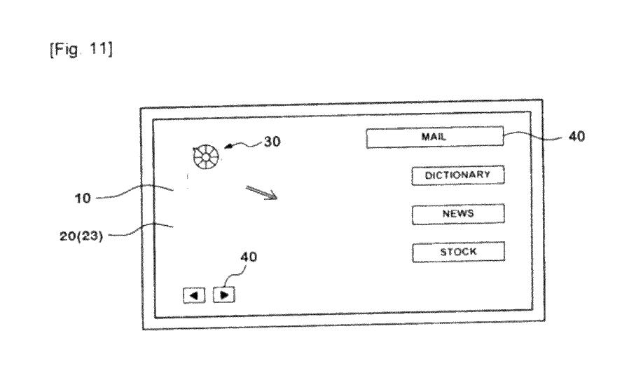

Meanwhile, as shown in FIG. 11, when the display screen 10 is configured to be a device which can detect a contact movement or a contact of an input tool such as a finger or a stylus pen like a touch screen, the input tool 20 may include an input device (hereinafter, referred to as an “input device 2”), which is a filed invention (patent application no. 2008-0038457) in advance by the same inventor as this application.

More specifically, the input device 2 includes a detection input unit 23 for detecting the first direction input and the second direction input, and a controller for extracting first data corresponding to the first direction input of the instruction location from the memory and inputting the data when the first direction input is performed and extracting the second data corresponding to the second direction input of the instruction location from the memory and inputting the data when the second direction input is performed.

The first direction input contactly moves to one of a plurality of instruction locations radially spaced apart from each other based on the reference location and is arranged on the display screen 10, and the second direction input pressurizes one of the instruction locations are independently performed.

At this time, the plurality of instruction locations are generated to correspond to the plurality of selection keys 33 and have numbers corresponding to the number of a plurality of selection keys 33. When the first direction input and the second direction input are performed by the detection input unit 23, the controller determines that the selection key 33 corresponding to an instruction location where the direction input is performed is selected, and performs a selection instruction of an object 40 corresponding to the selection key 33.

Further, in the input device 2, since the reference location is configured to correspond to a location corresponding to the selection key 33 disposed in the center of the selection keys 33, the reference location may be changed according to a location of the expansion cursor 30.

Furthermore, the detection input unit 23 may be configured to have only a touch screen, or may be used together with a touch screen such as a pressure sensor and a tactile sensor for increasing the detection performance for a movement and pressurization of a finger.

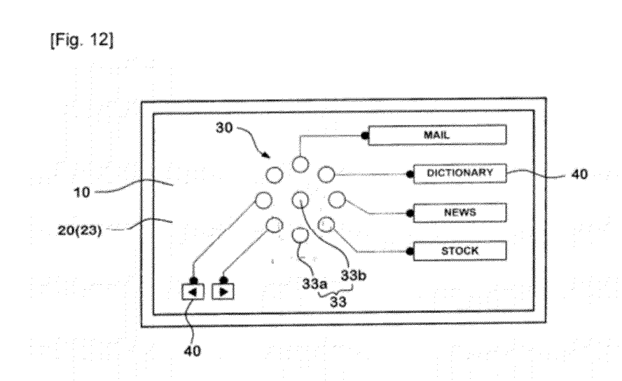

In addition, when a user moves his/her finger on the display screen such as a touch screen while touching the expansion cursor 30 shown in FIG. 11 by using his/her finger, the expansion cursor 30 is moved along with a movement of the finger. Here, shapes and structures of the expansion cursor and the basic cursor may be any of geometrically possible plane or solid figures as described above and may be changed according to an environment or a taste by a user or a person skilled in the art and then implemented. Further, when the expansion cursor 30 approaches within a predetermined distance from the object 40 displayed on the display screen 10, the expansion cursor 30 is activated on the display screen 10 and then the selection key 33 and the object 40 are connected as shown in FIG. 12. Accordingly, the user can execute the object 40 connected to a specific selection key 33 by performing the first direction input through a contact movement by her/his finger for the selection key positioned at a location corresponding to an instruction location or the second direction input through pressurization. Here, the expansion cursor 30 may be activated from the beginning to be operated and it is the same as described above.

Further, usage examples of the aforementioned input device 1 may be applied to other inputs through the input device 2 without any change.

### Second Embodiment

Next, a second embodiment of the present invention will be described. In this embodiment, the same reference numeral will be used for the same element as the first embodiment of the present invention.

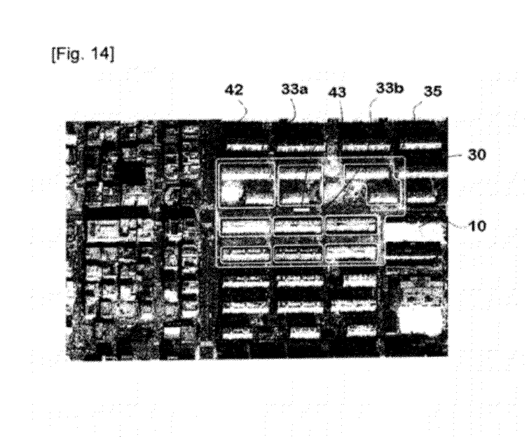

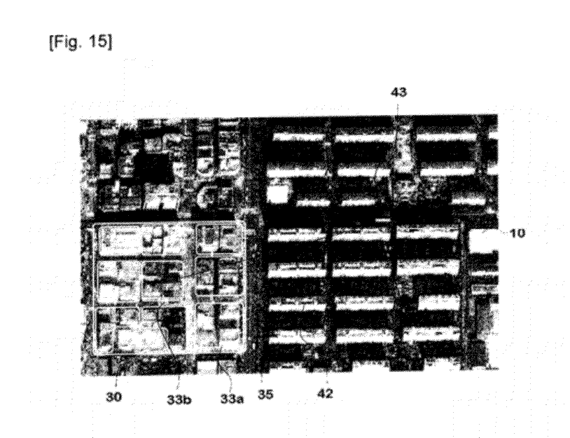

FIGS. 14 and 15 illustrate an implementation example for the second embodiment according to the present invention.

As shown in FIGS. 14 and 15, in this embodiment, roads and buildings are implemented on a displayed map in the display screen 10. At this time, when a corresponding building is selected, it is preferable that an indication for indicating a building name or a store name in the building is represented on the map for some or all of the buildings 42 on the map or in a separate window. That is, in this embodiment, the building 42 is an object.

Further, in this embodiment, the expansion cursor 30 is positioned at a location on the map, and each selection key 33 is arranged for buildings adjacent to the location. At this time, in this embodiment, the selection key 33 of the expansion cursor 30 is not connected to the object, which is indicated as the building 42, and the selection keys 33a and 33b are indicated such that the selection keys are overlapped with the building 42 as shown in FIGS. 14 and 15. Accordingly, the user can identify information on the building corresponding to the selection key by selecting the specific selection keys 33a and 33b through the input means.

Further, a region indication unit 35 is indicated in surroundings of the selection keys 33a and 33b arranged on the map in order to enable the user to accurately recognize the selection keys on the map. That has the same principle in which the selection key and the object are recognized by the connection line.

Meanwhile, this embodiment is used for navigation. That is, when a vehicle 43 is driven, the expansion cursor 30 may be arranged based on a location of the vehicle 43 in the navigation displaying a map on which the location of the vehicle is indicated. At this time, when the vehicle is driven on a road where there is no building, the expansion cursor is arranged on the vehicle. When the vehicle is driven on a road where there is a building, the expansion cursor is expanded and the selection key is arranged on the building.

For example, when the vehicle 43 moves on the map, the selection keys 33a and 33b are arranged on the building 42 positioned within a distance set based on the vehicle 43 as shown in FIG. 14. Further, as the vehicle 43 continuously moves, the selection keys 33a and 33b are arranged on neighbor buildings based on a location of the current vehicle 43.

At this time, the selection keys 33a and 33b with various shapes may be arranged on the building, but it is preferable that the selection keys are arranged in a form by which the user can easily recognize a corresponding relation with the input means. For example, when there are 9 selection keys positioned at the center and the surroundings of the expansion cursor, the selection keys may be arranged on each of the buildings in a matrix form. Accordingly, the user can instinctively grasp that the building positioned at the center corresponds to the central selection key 33b, so that the user can identify information on the building 42 by selecting the central selection key 33b.

Meanwhile, the user desires to identify information on a building positioned within more than a set distance from the current vehicle 43, the user move the expansion cursor 30 on the map by using the input means (in a direction indicated by an arrow in FIG. 15). At this time, the expansion cursor 30 is separated from the vehicle 43 and selection keys 33a and 33b are arranged for neighbor buildings based on a location where the expansion cursor is moved as shown in FIG. 15.

As described above, the expansion cursor according to this embodiment of the present invention is used to identify information on the building displayed on the map, so that the information on the intended building may be more easily and quickly obtained.

Next, a modification example from this embodiment will be described.

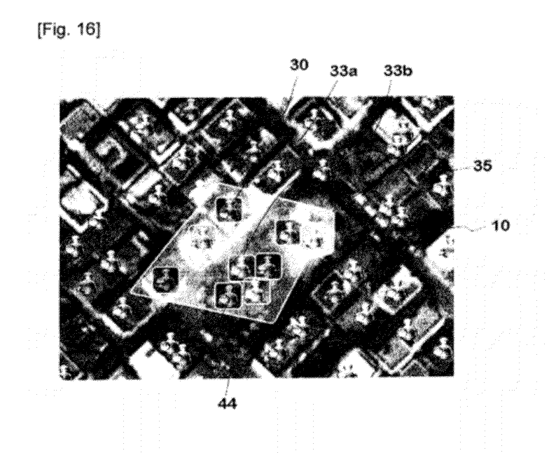

FIG. 16 illustrates the modification example for the second embodiment according to the present invention.

As shown in FIG. 16, in the modification example, a location of a person 44 is indicated on the map. At this time, a location of each person 44, for example, is set based on a specific site on an internet where the current user access, an IP address of people who log in a program, or addresses of acquaintances input by the user.

Further, a current location of the user is indicated on the map, and the location is determined by an IP address of the user or an input of the user.

At this time, the expansion cursor 30 is basically positioned on the location of the user and the selection keys 33a and 33b are arranged for people positioned within a set distance. In addition, as shown in FIG. 16, the expansion cursor 30 may be moved through the input means. When the expansion cursor is moved, the selection keys are arranged for people positioned at surroundings of the expansion cursor.

Accordingly, when the user desires to identify information on specific people among people having the arranged selection keys 33a and 33b, the user can select the selection keys corresponding to the people. Then, the information on the people may be indicated in a location of the map or an opened separate window.

Further, in an example shown in FIGS. 14 to 16, a search window is activated to specially designate information, which the user desires to identify, and then the information may be indicated when the user desires to identify only information on a specific object, for example, the user desires to indicate only famous restaurants introduced through a TV, which are positioned adjacent to a current location of the user or the latest buildings among buildings positioned within a specific region on the map, accessors having a specific conditions among people who currently access an internet. It is apparent to those skilled in the art that the activation of the search window is available through the use of a separate function key or a mode conversion key, or an input control such as pressing the central selection key 33b during a predetermined time or designating the number of presses.

### Third Embodiment

Next, a third embodiment of the present invention will be described. In this embodiment, the same reference numeral will be used for the same element as the first embodiment of the present invention.

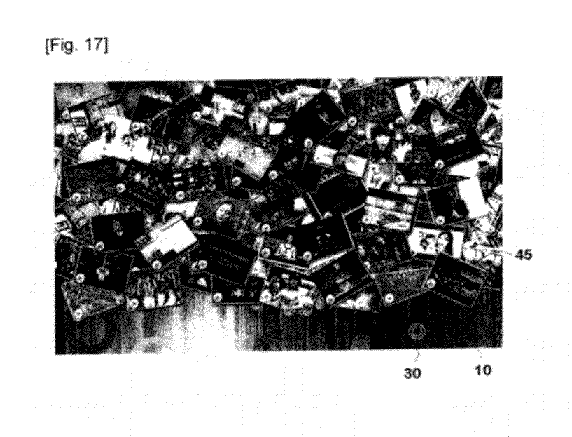

FIGS. 17 to 19 illustrate an implementation example for the third embodiment according to the present invention.

In this embodiment, when a plurality of objects are randomly arranged on the display screen, if the expansion cursor 30 approaches the objects, the objects are rearranged in a preset form and displayed on the screen.

At this time, when there are 9 selection keys 33 and 10 objects or more positioned within a set distance from the expansion cursor 30, the objects are selected according to an arrangement standard such as an order of a selection frequency, a changed date, or an alphabet (or Korean alphabet), and the selection keys are arranged on the selected object according to the above method.

Further, the objects may be arranged in a matrix form, and the set form refers to the matrix form. Accordingly, each selection key of the expansion cursor is arranged on each object arranged in the matrix form, so that the user can easily select the specific object.

In this embodiment, a plurality of dynamic images 45 including various images are arranged on the display screen 10 as the object, and parts of the dynamic images 45 are arranged in the matrix form according to an movement of the expansion cursor 30 and the selection keys 33a and 33b are arranged on the dynamic images 45.

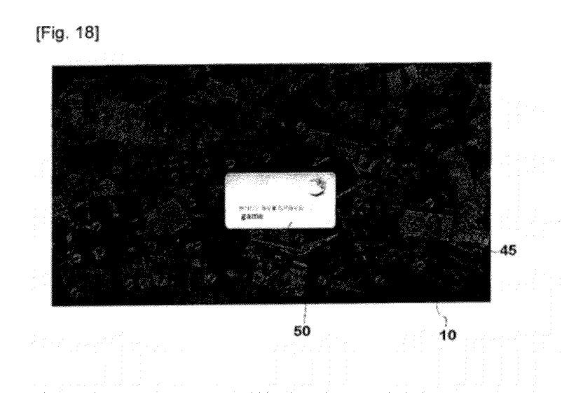

Further, in this embodiment, it may be configured that only a dynamic image corresponding to a specific keyword among various dynamic images 45 arranged on the display screen 10 is extracted. That is, as shown in FIG. 18, when the user desires to watch a dynamic image for a “game”, the user first inputs a “game” in a search window 50.

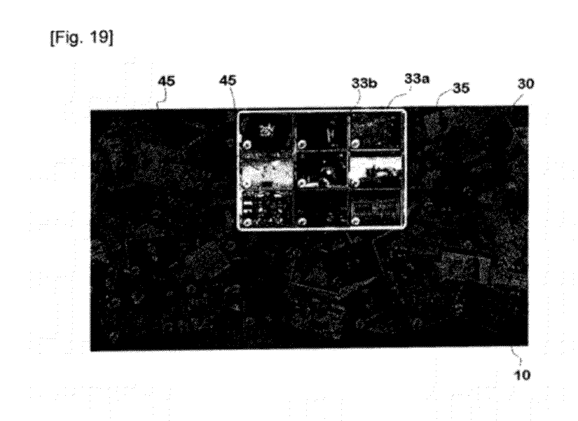

When the user moves the expansion cursor 30 adjacent to the plurality of dynamic images 45, a dynamic image related to a “game” among the dynamic images is arranged in the matrix form and the selection keys 33a and 33b are arranged for the dynamic images as shown in FIG. 19. Accordingly, the user can play the dynamic image corresponding to a specific selection key by identifying images indicated for the dynamic images arranged on the selection keys and selecting the specific selection key. At this time, a word “game” which is a target for the search is indicated in a side of the expansion cursor 30.

Next, a modification example from this embodiment will be described.

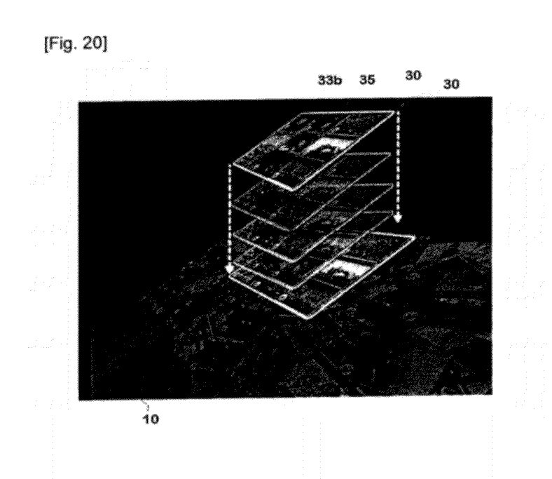

FIG. 20 illustrates the modification example for the third embodiment according to the present invention.

As shown in FIG. 20, in the modification example, when the larger number of a plurality of objects than the number of selection keys is arranged on the selection keys, the selection keys are arranged in a 3-dimensional form and each object is arranged on each selection key. That is, as shown in FIG. 20, when there are 9 selection keys 33a and 33b, and 10 or more dynamic image contents 45, initial 9 dynamic images 45 selected according to the aforementioned arrangement standard are allocated to the selection keys 33a and 33b arranged on a top 2-dimensional plane in the matrix form, respectively.

Accordingly, the user can select a specific dynamic image corresponding to the selection keys arranged on the top 2-dimensional plane through an input control for the input means, and also select a specific dynamic image among dynamic images arranged on the selection key by activating the selection key on a bottom 2-dimensional plane,

Here, the activation of the selection key is implemented as a type in which a 2-dimensional plane of another layer is relatively pale in comparison with the 2-dimensional plane including the selection key. Alternatively, the activation may be implemented as a type in which the 2-dimensional plane including the selection key is enlarged or moved to an empty space of the display screen and then displayed.

Further, an arrow shown in FIG. 20 indicates that a 2-dimensional plane activated by an input control of the user may be moved.

In addition, when the object is a dynamic image, a representative image for the dynamic image is indicated as the object.

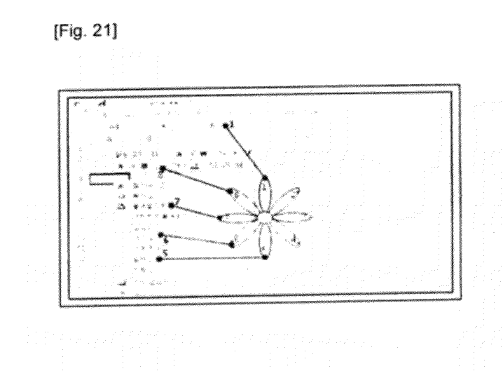

Moreover, it is apparent to those skilled in the art that the present invention may be applied to other general office applications to be executed and may be easily operated as shown in an example of FIG. 2 in which the multidirectional expansion cursor according to the present invention is implemented in Excel of Microsoft Corporation widely used as an office application. In a conventional office application, when a user desires to open a location or a folder which should be input, the user can execute the folder by accurately placing a cursor by using a mouse. However, when the expansion cursor of the present invention is applied, for example, when the expansion cursor is closely moved to a folder or a tool window, the number of adjacent folder or tool windows corresponding to the number of selection keys 33a is connected to the selection keys all at once. Accordingly, through a single direction input control in the connection state, a selection of a corresponding folder or tool window, an input performed in the selected input window or cell, and various instructions may be easily and quickly performed as shown in FIG. 21. A description for a detailed control method is omitted for convenience since those skilled in the art can easily implement through the description discussed in the embodiments. Particularly, when the present invention is applied to a conventional portable terminal of which a screen size is limited and an input means is complicated and cumbersome, the use of free office applications are nearly impossible in the conventional portable terminal, but it becomes possible to freely operate the office applications even in the portable terminal by applying the present invention.

### Fourth Embodiment

Next, a fourth embodiment of the present invention will be described. In this embodiment, the same reference numeral will be used for the same element as the aforementioned embodiments of the present invention.

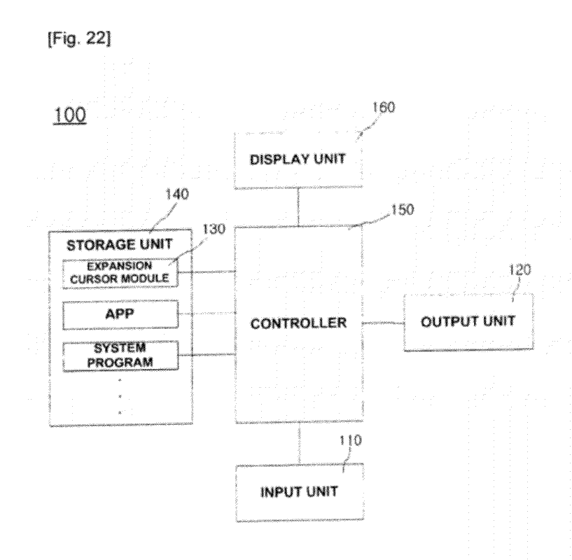

FIG. 22 is a block diagram schematically illustrating a construction of a user terminal by which the present invention is implemented. The user terminal 100 includes an input unit 110, an output unit 120, a storage unit 140, a controller 150, and a display unit 160. Further, the user terminal includes a communication interface (not shown) and downloads applications and various contents through an internet or a mobile communication network to store the downloaded applications and contents in the storage unit 140. The user terminal 100 according to an embodiment of the present invention may be a desktop PC, a laptop PC (or notebook PC), a palmtop PC, a PDA (Personal Digital Assistant), a PMP (Personal Multimedia Player), a telematics terminal, a navigation, a mobile phone, a smart phone such as Blackberry, and a game terminal such as X-Box, Playstation, or Nintendo DS.

The input unit 110 refers to an input means for receiving an input of various information or instructions from a user. The input unit 110 moves the expansion cursor such as a mouse pointer or receives an input of an execution instruction from the user to provide the input to controller 150. A keyboard, a directional key, a rotational key, a touch key, a touch screen, a mouse, a keypad of a mobile terminal, and a jog dial as well as the aforementioned input device 1 and input device 2 may be used as the input unit 110.

The output unit 120 outputs general information required for operating the user terminal 100 to a screen, or executes performed results generated by processing instruction input by the user through the controller 150. For example, that corresponds to a sound output, an image output, and an execution or an activation of applications. When a certain application (APP) is executed according to an input of the user, the controller 150 processes the application and the corresponding application may be operated. Particularly, when the user inputs an instruction for activating an expansion cursor module 130 by using the input means, the controller 150 processes the instruction and the expansion cursor 130 is executed.

Further, the display unit 160 displays a performed result generated by operating the expansion cursor module through the controller 150 in order to enable the user to identify the result. A picture tube, LCD, LED, and plasma typed monitor or TV, or a liquid crystal display for a user interface and outputs of various execution instructions of the user may be used as the display unit 160. Further, when an example of the display unit 160 is a touch screen, the touch screen performs a display function of various information pieces and may be used as the input unit.

The storage unit 140 stores a data file generated according to an operating system, a system program, and various applications (APP) required for an operation of the user terminal 100, and an input instruction execution result of the user. Particularly, the storage unit 140 includes the expansion cursor module 130 according to embodiments of the present invention and stores various data and programs required for an operation of the expansion cursor.

The expansion cursor module 130 may be implemented through a program for implementing a function corresponding to the embodiments in the user terminal or through a recording medium in which the program is recorded, and stores and manages various information pieces and data files required for an execution of the multidirectional expansion cursor.

The controller 150 includes an operation module such as a microprocessor, and controls the elements to handle general operations of the user terminal 100. Particularly, the controller 150 controls the expansion cursor module 130 to enable the multidirectional expansion cursor according to embodiments of the present invention to be smoothly operated.

### INDUSTRIAL APPLICABILITY

The present invention may be applied to various user terminals. Particularly, when the present invention is applied to a mobile environment, a user can quickly and accurately select an intended object among one or more objects by closely placing a cursor on a specific object even on a screen having a limited size.

While this invention has been particularly shown and described with reference to preferred embodiments thereof, these embodiments are provided so that this disclosure will be thorough and complete, and will fully convey the concept of the invention to those skilled in the art. It will be understood by those skilled in the art that various changes in form and details may be made therein without departing from the spirit and scope of the invention as defined by the appended claims.

1. A method of implementing a multidirectional expansion cursor, the method comprising:
generating an expansion cursor displayed on a display screen to be moved according to an input control of a user, and partitioned by a plurality of selection keys;
making one or more objects selectable on the display screen correspond to the selection keys and displaying them on the display screen; and
selecting the selection key corresponding to an intended object in order to execute the intended object among the one or more objects.

2. The method of claim 1, wherein, in generating of the expansion cursor, a basic cursor, which can select an object displayed on the display screen, is connected to an end of the expansion cursor to be displayed, positioned in a center of the expansion cursor to be displayed, or not displayed at all.

3. The method of claim 1, wherein, in generating of the expansion cursor, the expansion cursor is partitioned by a plurality of radially disposed sections, and a selection key is indicated in each of the partitioned sections.

4. The method of claim 2, wherein, in generating of the expansion cursor, the objects correspond to the selection keys such that the number of objects corresponds to the number of selection keys.

5. The method of claim 2, wherein, in making of the objects correspond to the selection keys, when the expansion cursor approaches within a set distance from the one or more objects, the corresponding objects are individually connected to the selection keys.

6. The method of claim 2, wherein, in making of the objects correspond to the selection keys, when the expansion cursor approaches within a set distance from the one or more objects, selection keys arc disposed for each of corresponding objects according to properties of objects displayed on the display screen, and the selection keys are indicated by a connection line, a matrix form, or an emphasis indication.

7. (canceled)

8. The method of claim 2, wherein, in making of the objects correspond to the selection keys, when the expansion cursor approaches within a set distance from the one or more objects, a shape of the expansion cursor is changed and the corresponding object and the selection key are connected such that they correspond to each other.

9. The method of claim 1, wherein the selection key comprises a central selection key for performing a selection function or a release function, and a neighbor selection key connected to the object.

10. The method of claim 1, wherein, in making of the objects correspond to the selection keys, objects randomly disposed on the display screen are rearranged in a preset form, and the selection keys arc disposed on the rearranged objects, respectively.

11. The method of claim 10, wherein the rearranged objects in the preset form are selected and disposed according to a preset arrangement standard.

12. The method of claim 11, wherein the preset form corresponds to a matrix form.

13. The method of claim 11, wherein, when the number of a plurality of objects displayed on the display screen is larger than the number of selection keys, the objects are expanded and disposed in a 3-dimensional form including a plurality of 2-dimensional planes, and each of the selection keys is arranged on each of the objects displayed on a currently activated 2-dimensional plane among objects disposed in a 3-dimensional form.

14. The method of claim 13, wherein the selection keys are moved to objects indicated on another 2-dimensional plane arranged in a 3-dimensional form and arranged according to an input control of a user, and the objects indicated on the 2-dimensional plane, to which the selection keys has been moved, are newly activated.

15. The method of claim 2, wherein the expansion cursor is moved by a predetermined input means, and each of the selection keys of the expansion cursor is selected by a control of the input means.

16. The method of claim 15, wherein the input means comprises:
an input unit for independently performing a first direction. input, which is arranged at surroundings of the display screen and moving to one of a plurality of instruction locations radially spaced apart from a reference location, and a second direction input of pressing one of the instruction locations;
a first detection unit for detecting the first direction input;
a second detection unit for detecting the second direction input;
a controller for extracting first data corresponding to the first direction input of the instruction location from a memory when the first direction input is performed, and extracting second data corresponding to the second direction input of the instruction location from the memory when the second direction input is performed, and then inputting extracted data.
wherein the plurality of instruction locations are generated to correspond to locations of the plurality of selection keys and to have the number corresponding to the number of a plurality of selection keys, and the controller determines that the selection key corresponding to an instruction location where the direction input is performed is selected when the first direction input or the second direction input is performed and performs a selection instruction for an object corresponding to the selection key.

17. The method of claim 15, wherein the input means comprises:
a detection input unit for detecting each of direction inputs, the direction inputs including a first direction input arranged at surroundings of the display screen and moving to one of a plurality of instruction locations radially spaced apart from a reference location and a second direction input pressing one of the instruction locations, and the first direction input and the second direction input being independently performed;
a controller for extracting first data corresponding to the first direction input of the instruction location from a memory when the first direction input is performed, and extracting second data corresponding to the second direction input of the instruction location from the memory when the second direction input is performed, and then inputting extracted data,
wherein the plurality of instruction locations are generated to correspond to locations of the plurality of selection keys and to have the number corresponding to the number of a plurality of selection keys, and the controller determines that the selection key corresponding to an instruction location where the direction input is performed is selected when the first direction input or the second direction input is performed and performs a selection instruction for an object corresponding to the selection key.

18. The method of claim 2, wherein, in making of the objects correspond to the selection keys, a search window for extracting objects having desired information and properties from the objects and arranging the extracted objects is activated.

19-21. (canceled)

22. A multidirectional expansion cursor, which is displayed on a display screen and can be moved according to an input control of a user, the multidirectional expansion cursor comprising:
a plurality of selection keys,
wherein the selection keys are displayed on the display screen such that the selection keys correspond to one or more object selectable on the display screen, and when an object corresponding to an intended object among the one or more objects is selected by an input control of a user, the intended object is executed.

23-42. (canceled)
